(19) United States
(12) Patent Application Publication
(10) Pub. No.: US 2005/0127555 A1
(43) Pub. Date: Jun. 16, 2005

(54) Filled granulates consisting of high or ultra-high molecular weight polyethylenes and method for producing said granulates

(76) Inventors: Meinhard Gusik, Oberhausen (DE); Stanislaw Haftka, Oberhausen (DE); Kerstin Luedtke, Hamminkeln (DE)

Correspondence Address: CONNOLLY BOVE LODGE & HUTZ, LLP, P O BOX 2207, WILMINGTON, DE, 19899, US

(21) Appl. No.: 10/511,529

(22) PCT Filed: Apr. 15, 2003
(86) PCT No.: PCT/EP03/03903

(30) Foreign Application Priority Data
Apr. 18, 2002 (DE) 102-17-232.3

(51) Int. Cl. B29C 47/38

(52) U.S. Cl. 264/143; 264/211; 264/211.21

(57) ABSTRACT

Filled pelletized materials made from high- or ultrahigh-molecular-weight polyethylenes and process for their production Pelletized materials made from high- and/or ultrahigh-molecular-weight polyethylene are described. The pelletized materials comprise fillers and/or reinforcing materials and can be processed by processes known per se to give moldings. The pelletized materials may be produced on a specifically designed extruder.

Filled pelletized materials made from high- or ultrahigh-molecular-weight polyethylenes and process for their production.

The present invention relates to pelletized materials provided with additives and comprising (ultra) high-molecular-weight polyethylenes, and to a process for producing pelletized materials from (ultra) high-molecular-weight polyethylenes comprising additives.

High- and ultrahigh-molecular-weight polyethylenes (also termed HMWPE or HMW polyethylene or, respectively, UHMWPE or UHMW polyethylene below) are used in many sectors of industry because they have excellent properties, such as high abrasion resistance, good frictional behavior, excellent toughness performance, and high chemicals resistance. Due to their advantageous mechanical, thermal, and chemical behavior, HMWPE and UHMWPE have found uses as versatile materials in a very wide variety of application sectors. Examples which may be mentioned are the textile industry, mechanical engineering, the chemical industry, and conveying systems. These ultrahigh-molecular-weight polymers are thermoplastics, but require specific measures and/or addition of auxiliaries if they are to be processed on the customary apparatus suitable for thermoplastics processing.

For example, EP-A-889,087 describes a molding composition which comprises, alongside UHMWPE, a high-density polyethylene, an anti-oxidant, a salt of a fatty acid, an amide wax, and, as a further component of the blend, a fluoroelastomer. This molding composition can be processed by extrusion in customary apparatus. U.S. Pat. No. 5,352,732 describes a molding composition which can be processed to give homogeneous composites of UHMWPE and filler materials. Here, a UHMWPE with bimodal molecular weight distribution is used.

Another reason for processing UHMWPE is to permit the use of specific apparatus and/or specific processing conditions. For example, EP-A-190,878 describes the production of extruded and drawn filaments from UHMWPE, using a specific single-screw extruder.

FR-A-2,669,260 discloses a specifically designed extruder screw which can be used for processing UHMWPE. Another apparatus, and also a process for extruding UHMWPE, is disclosed in EP-A-590,507. Here, a specifically designed twin-screw extruder is used. This apparatus can process the polymers under non-aggressive conditions, giving profiles with satisfactory surfaces which are free from pores and depressions and have no internal stresses.

Pelletized materials made from polymers have been introduced in many sectors of plastics processing. Their good metering and processing properties make them suitable for easy production of mixtures, and as precursors for the production of moldings, for example in the injection molding process. The basis for the advantages of pelletized materials is that the processibility of materials in the predominant supply form, pulverulent or fine-particle condition, is sometimes difficult, and this can limit the usage potential of materials. For example, when ultrahigh-molecular-weight polyethylene powder is processed by injection molding there are known to be feed problems with injection molding cylinders and extruder barrels which, for example, do not have the cooled grooved structure advantageous for powder processing. In addition, the handling of pulverulent or fine-particle ultrahigh-molecular-weight polyethylenes often leads to dusting problems, and this can lead to rejection of the material by the processor, e.g. in the case of injection molding and extrusion operations, for health reasons associated with the product. The dusting problem encountered with pulverulent or fine-particle ultrahigh-molecular-weight polyethylenes requires appropriate safety equipment to dissipate electrostatic charge in closed storage and conveying systems (silo systems and storage containers) because there is a risk of dust explosions, and this increases the cost of new systems. When the traditional processing technology for UHMWPE by the pressure-sintering method is used, the pulverulent form is the cause of the known “blow out” phenomenon (blow-out of powder particles into the environment) during closing of the presses, requiring considerable cleaning work in the entire environment of the presses. The only solution here is then to close the presses slowly in order to minimize the amount of powder expelled, but this costs time and subsequent reductions in capacity of the presses.

The low flowability of UHMWPE powders can moreover result in production difficulties during processing by injection molding, ram extrusion, or extrusion, since bridges can form in the storage containers, restricting the flow of material. Equally, the poor flowability of UHMWPE powders prevents the direct production of thin sheets (thickness<8 mm, depending on mold dimensions) by the pressure technique, since it is very difficult to distribute the powder uniformly over the mold surface, and/or the above-mentioned “blow out” causes channels to form in the powder layer when the press is closed, and these can then lead to cavities or depressions in the resultant pressed sheet and therefore to rejection of those products.

A previous proposal to eliminate these disadvantages produces cold-compressed pellets from the powder (cf. DE-A-43 210 351). However, it has been found that these pellets lack adequate grain strength. The consequence of this was that the pellets had inadequate stability during transport, and that a considerable proportion of the pressed pellets broke down again to give powder during processing. The disadvantages listed above therefore appeared again during processing. In addition, the method of producing the pellets requires the use of a suitable mold of different thickness depending on the nature of the modification, e.g. with color pigments or fillers, and the result can be enormous set-up costs.

These problems do not arise during pelletization by way of the melt, since added materials, such as pigments, additives, and fillers, can be processed without difficulty and without altering the structure of the machine.

There has been no description to date of pelletized materials comprising high- or ultrahigh-molecular-weight polyethylenes and fillers and/or reinforcing materials.

It has now been found possible to produce pelletized materials of this type with the aid of a particular extrusion process.

The present invention provides pelletized materials comprising high- or ultrahigh-molecular-weight polyethylenes and fillers and/or reinforcing materials.

High- or ultrahigh-molecular-weight polyethylenes which may be used are any desired homo- and copolymers, as long as these have high or, respectively, ultrahigh molecular weight and derive from ethylene as monomer, where appropriate used in combination with other ethylenically unsaturated hydrocarbons, or combinations of these.

HMWPE is a polyethylene whose molar mass, measured by viscometry, is at least 1×10⁵ g/mol, preferably from 3×10⁵ to 1×10⁶ g/mol. UHMWPE is polyethylene whose average molar mass, measured by viscometry, is at least 1×10⁶ g/mol, preferably from 2.5×10⁶ to 1.5×10⁷ g/mol. The method for determining molar mass by viscometry is described by way of example in CZ—Chemische Technik 4 (1974), 129.

When they are used as starting materials for producing the pelletized materials of the invention, these UHMW polyethylenes may be in particle form with a very wide variety of morphology, in particular in powder form. The particle size D₅₀ of UHMW polyethylenes used according to the invention is usually from 1 to 600 μm, preferably from 20 to 300 μm, in particular from 30 to 200 μm.

The fillers and/or reinforcing materials present in the pelletized materials of the invention may be a very wide variety of additives which give desired properties to the product for further processing. These include dyes, organic or inorganic pigments, such as azo and diazo pigments, metal complex pigments, titanium dioxide, iron oxide, chromium oxide, ultramarine pigments, aluminum silicate pigments, and carbon black; antistats, such as carbon black; reinforcing agents, such as fibers made from a very wide variety of materials, such as glass, carbon, or metal; or mineral fillers, such as calcium carbonate, kaolin, clays, titanium dioxide, alumina trihydrate, wollastonite, talc, pyrophyllite, quartz, silicates, barium sulfate, antimony oxide, mica, calcium sulfate, magnesium hydroxide, and feldspar; synthetic fillers, such as carbon black, synthetic silicates, solid or hollow microspheres, glass-based additives, metallic additives, such as [powders, e.g.] aluminum powders, iron powders, or silver powders, or magnetic additives.

Preferred fillers are carbon black, graphite, metal powders, such as aluminum powder, mineral powders, such as wollastonite, reinforcing fibers, such as glass fibers, carbon fibers, or metal fibers, including whiskers, or glass beads.

The content of fillers and/or reinforcing materials in the pelletized material of the invention is usually up to 60% by weight, based on the pelletized material. The preferred range is from 0.1 to 40% by weight.

The pelletized materials of the invention may have any desired shape prescribed by the nature of the production process. For example, the pelletized material may be lamellar, optionally with rounded edges. The diameter of the particles of pelletized material is usually from 0.5 to 5 mm, in particular from 1.5 to 4 mm.

The pelletized material of the invention, with or without additives, may be produced using a modified apparatus of EP-B-590,507.

The invention also provides a process for producing pelletized materials comprising HMW and/or UHMW polyethylenes and fillers and/or reinforcing materials with the aid of an extruder, preferably a single-screw extruder, the sections of whose screw are a feed section, a transition section, and a metering section, and the design of whose screw, at least in the transition section, is that of a barrier screw, encompassing the steps of:
a) introduction of pulverulent to small-particle HMW and/or UHMW polyethylene and of fillers and/or reinforcing materials into the feed section, which is a double-flighted screw section formed from a conveying region whose length is from 2 to 16 times the screw diameter, and a decompression region whose length is from 5 to 8 times the screw diameter, the screw here having a flight depth of from 4 to 10 mm in the region of the feed section,
b) transport of the HMW and/or UHMW polyethylene and of the filler and/or reinforcing material through the feed section with the aid of the screw,
c) transport of the HMW and/or UHMW polyethylene and of the filler and/or reinforcing material with the aid of the screw into the transition section, which is composed of a shear region whose length is from 1 to 6 times the screw diameter, and
d) transport of the HMW and/or UHMW polyethylene and of the filler and/or reinforcing material with the aid of the screw into the metering section, which encompasses a mixing region whose length is from 1 to 4 times the screw diameter,
e) transport of the HMW and/or UHMW polyethylene and of the filler and/or reinforcing material with the aid of the screw through a die of predetermined geometry, forming at least one extrudate strand, and
f) comminuting the at least one extrudate strand in a manner known per se.

Instead of the single-screw extruder described above, it is also possible to use appropriately designed extrusion systems such as twin-screw extruders or planetary-gear extrusion systems.

The process of the invention features the use of a specifically designed extruder. The screw geometry, the rotation rate, and the temperature profile along the screw housing ensure that no thermal degradation of the polymer occurs during the process as a result of degradation or decomposition, i.e. via cleavage of the molecular chains and thus reduction of average molar mass.

The conveying of the UHMW polyethylene and of the additives through the extruder usually takes place at temperatures of from 110 to 300° C., preferably from 130 to 200° C. The heat required can be introduced into the material in two ways: internally through the mechanical work carried out on the material, in the form of frictional heat, and externally by way of heaters.

The extrudate thus produced in the barrel of the extruder is introduced by means of the screw into a pelletizing die in order to mold strands. It has proven advantageous here for the holes in the pelletizing die or the inlets to the pelletizing die within the transition section to be filled with extrudate directly from the screw channel. Due to the high melt viscosity of UHMW polyethylenes and the resultant limited flowability of the melt, in the event that a die-face cutting system is used, with a knife bar rotating over the pelletizing die to cut the pellets to the required length, it is advisable for the holes to be arranged uniformly on the circumference of a circle.

The thickness of the pelletizing die is usually from 5 to 50 mm, preferably from 15 to 40 mm, and the diameter of the holes is from 0.5 to 5.0 mm, in particular from 1.5 to 4.0 mm.

The holes advantageously have conical inlets, the inlet angle being from 0.5 to 5°, preferably from 0.8 to 1.5°. The result is a pressure rise in the die land, and this is adjusted via appropriate settings of the cross-section size so that the thermoplastic particles sinter together to give a homogeneous composition, giving the moldings a smooth surface. The strands discharged from the pelletizing die may be pelletized using commercially available pelletizers, such as strand pelletizers (also termed the cold-cut process), die-face pelletizers, water-cooled die-face pelletizers, or underwater pelletizers.

The process of the invention can process various grades of HMW or UHMW polyethylenes together with fillers and/or reinforcing materials, and also mixtures of various high- and/or ultrahigh-molecular-weight polyolefins together with fillers and/or reinforcing materials, to give pelletized material.

Besides HMW and/or UHMW polyethylenes, the pelletized materials of the invention may comprise other polymeric constituents of a mixture. Examples of these are polyethylenes whose molar mass is from about 10 000 to about 600 000 g/mol.

The proportion of these polymers in the pelletized materials may be from 1 to 90% by weight, preferably from 10 to 70% by weight. The polymer or the polymer mixture may moreover comprise added materials. They include conventional processing aids and stabilizers, such as antistats, corrosion inhibitors, light stabilizers and heat stabilizers, such as UV stabilizers, and antioxidants.

The pelletized materials of the invention may be processed to give various moldings. Selected fillers and/or reinforcing materials may be added to give these moldings desired properties. For example, addition of glass fibers, glass beads, or wollastonite increases the modulus of elasticity and the surface hardness of the products produced from these pelletized materials. These properties are demanded, for example, for inlet and guiding elements for packaging systems and for draw-off systems, in transport technology, conveying systems, and storage systems, and in the paper and pulp industry.

Products can be rendered antistatic by embedding carbon black in HMW or UHMW polyethylenes. Products made from HMW or UHMW polyethylene and provided with carbon black additive also have improved UV resistance. Applications for these materials are inlet and guiding elements in packaging systems and draw-off systems, in transport technology, conveying systems, and storage systems, and also the sports and leisure sector.

Pelletized materials made from HMW or UHMW polyethylene and aluminum/graphite mixtures can be processed, for example, to give products which have to provide improved thermal conductivity. This is a particular requirement in the case of highly stressed machinery components where frictional heat has to be dissipated, e.g. bearings or pile-driver cushion head linings. The products produced from these pelletized materials also have improved sliding friction behavior.

Further processing may take place using the processing methods known to the skilled worker for HMW or, respectively, UHMW polyethylenes. Examples of these are injection molding, screw extrusion, ram extrusion, other compression processes, and sintering.

The invention also provides the use of the pelletized materials described above for producing the apparatus and components mentioned.

In the examples below, the production and the properties of a variety of pelletized materials provided with additives are described by way of example, but the invention is not restricted to the embodiments presented.

Experimental Section

Constituents used:

Table 1 shows the properties of the UHMWPEs used (supplier: Ticona GmbH, Kelsterbach, Germany; trade name: GUR®). These values were determined using the following test methods:

| | |
|---|---|
| Density: | ISO 1183, Method A |
| Viscosity number: | ISO 1628 part 3, |
| | conc. in decahydronaphthalene: 0.0002 g/ml |
| Bulk density: | DIN 53 466 |
| Offset yield stress: | ISO 11542-2 |
| Notched impact strength: | ISO 11542 part 2 |
| Yield stress: | ISO 527 part 1 and 2 |
| Modulus of elasticity: | ISO 527 part 1 and 2 |
| Surface resistivity: | ISO 291-23/50 |
| Ball impression hardness | ISO 2039, part 1 |
| (30 sec value; test force | |
| 358 N) | |

Wear, using the sand-slurry method (relative to GUR 4120=100)

a) Range of properties of polyethylenes used

TABLE 1

| | Range of properties |
|---|---|
| Properties | of polyethylenes used |
| Density (g/cm³) | 0.92-0.96 |
| Viscosity number (ml/g) | 200-5 000 |
| Average molar mass*⁾ (g/mol) | 1.4 · 10⁵-1.5 · 10⁷ |
| Offset yield stress (MPa) | 0.1-0.8 |
| Bulk density (g/cm³) | 0.20-0.5 |
| Yield stress (MPa) | ≧17 |
| Modulus of elasticity (MPa) | 570-1 060 |
| Notched impact strength (kJ/m²) | 25-250 |
| Wear (by sand-slurry method) | 70-250 |
| Surface resistivity (Ω) | >10¹² |

*⁾molar mass calculated from the Margolies equation
M = 5.37 · 10⁴ · [η]^{1.49};
η in dl/g

b) Additives used

The values given in the table are those published on the manufacturer's data sheets.

TABLE 2

| | Carbon | | | | | |
|---|---|---|---|---|---|---|
| | black | Graphite | Aluminum | Wollastonite | Glass beads | Glass fiber |
| Form | powder | powder | powder | powder/ | beads | ground glass |
| | | | | pelletized | | fiber filler |
| | | | | material | | |
| Color | black | graphite- | gray | white | colorless | white/pale |
| | | gray | | | | gray |
| Density | 1.7-1.9 | 2.26 | 2.69 | 2.8-3.1 | 2.6 | 2.55-2.66 |
| (g/cm³) | | | | | | |
| MP (° C.) | >3 000 | — | 660 | 1 540 | about 730*⁾ | about 840*⁾ |

*⁾softening point

### EXAMPLES

The pelletized materials were produced by mechanical mixing of a defined UHMWPE with a particular additive constituent in a high-speed mixer. This mixture was then introduced to the extruder described.

The results from testing of the properties of each of the pelletized material compositions are presented in table 4.

### Example 1

Composition of pelletized material: 95% by weight of GUR 4113 and 5% by weight of carbon black.

### Example 2

Composition of pelletized material: 97.5% by weight of GUR 4113 and 2.5% by weight of carbon black.

### Example 3

Composition of pelletized material: 60% by weight of GUR 2122, 30% by weight of aluminum powder and 10% by weight of graphite.

### Example 4

Composition of pelletized material: 75% by weight of GUR 4113 and 25% by weight of wollastonite.

### Example 5

Composition of pelletized material: 95% by weight of GUR 4113 and 5% by weight of glass microbeads.

### Example 6

Composition of pelletized material: 70% by weight of GUR 2122 and 30% by weight of glass microbeads.

### Example 7

Composition of pelletized material: 70% by weight of GUR 2122 and 30% by weight of glass microbeads.

Properties of pelletized materials of the invention.

The data given were determined on test specimens under laboratory conditions, made from pressed sheets.

TABLE 4

| | | Notched | | | | |
|---|---|---|---|---|---|---|
| | | impact | Modulus of | Ball impression | | Surface |
| | Density | strength | elasticity | hardness | | resistivity |
| Example | (g/cm³) | (mJ/mm²) | (MPa) | (N/mm²) | Wear | (Ω) |
| 1 | 0.96 | 154 | 791 | 36 | 137 | 96 |
| 2 | 0.94 | 165 | 718 | 33 | 143 | 290 |
| 3 | 1.22 | 60 | 1 321 | 54 | 178 | 1.5 · 10⁸ |
| 4 | 1.12 | 30 | 1 028 | 42 | 229 | 7.6 · 10¹⁴ |
| 5 | 0.96 | 181 | 743 | 34 | 137 | 8.1 · 10¹⁴ |
| 6 | 1.12 | 43 | 868 | 40 | 210 | 2.6 · 10¹² |
| 7 | 1.15 | 82 | 1 367 | 45 | 259 | 7.1 · 10¹⁴ |

1. A pelletized material comprising high- and/or ultrahigh-molecular-weight polyethylene and fillers and/or reinforcing materials.

2. The pelletized material as claimed in claim 1, wherein the polyethylene is an ultrahigh-molecular-weight polyethylene.

3. The pelletized material as claimed in claim 1, wherein the amounts present of the fillers and/or reinforcing materials are up to 60% by weight, preferably from 0.1 to 40% by weight, based on the pelletized material.

4. The pelletized material as claimed in claim 3, wherein the fillers and/or reinforcing materials are selected from the group consisting of dyes, organic or inorganic pigments, antistats, reinforcing agents, mineral fillers, and synthetic fillers.

5. The pelletized material as claimed in claim 4, wherein the fillers and/or reinforcing materials are selected from the group consisting of carbon black, graphite, metal powder, in particular aluminum powder, mineral powder, in particular wollastonite, reinforcing fibers, in particular glass fibers, carbon fibers, or metal fibers, including whiskers, and glass beads.

6. A process for producing pelletized materials as claimed in claim 1 with the aid of an extruder, the sections of whose screw are a feed section, a transition section, and a metering section, and the design of whose screw, at least in the transition section, is that of a barrier screw, encompassing the steps of:
a) introduction of pulverulent to small-particle HMW and/or UHMW polyethylene and of fillers and/or reinforcing materials into the feed section, which is a double-flighted screw section formed from a conveying region whose length is from 2 to 16 times the screw diameter, and a decompression region whose length is from 5 to 8 times the screw diameter, the screw here having a flight depth of from 4 to 10 mm in the region of the feed section,
b) transport of the HMW and/or UHMW polyethylene and of the filler and/or reinforcing material through the feed section with the aid of the screw,
c) transport of the HMW and/or UHMW polyethylene and of the filler and/or reinforcing material with the aid of the screw into the transition section, which is composed of a shear region whose length is from 1 to 6 times the screw diameter, and
d) transport of the HMW and/or UHMW polyethylene and of the filler and/or reinforcing material with the aid of the screw into the metering section, which encompasses a mixing region whose length is from 1 to 4 times the screw diameter,
e) transport of the HMW and/or UHMW polyethylene and of the filler and/or reinforcing material with the aid of the screw through a die of predetermined geometry, forming at least one extrudate strand, and
f) comminuting the at least one extrudate strand in a manner known per se.

7. The use of the pelletized materials as claimed in claim 1 for producing moldings.

8. The use of the pelletized materials filled with glass fibers, with glass beads, and/or with wollastonite, as claimed in claim 1, for producing inlet and guiding elements for packaging systems and for draw-off systems, in transport technology, conveying systems, or storage systems, or in the paper and pulp industry.

9. The use of the carbon-black-filled pelletized materials as claimed in claim 1, for producing inlet and guiding elements for packaging systems and for draw-off systems, in transport technology, conveying systems, or storage systems, or else in the sport and leisure sector.

10. The use of aluminum- and/or graphite-filled pelletized materials as claimed in claim 1, for producing bearings or pile-driver cushion head linings.
